(19) United States
(12) Patent Application Publication
(10) Pub. No.: US 2025/0045808 A1
(43) Pub. Date: Feb. 6, 2025

(54) Method of Copyright Protection and Royalty Distribution Based on NFT and Smart Contracts

(71) Applicants: Charles Changqing Li, Cross River, NY (US); Zhizhuang Wu, Vancouver (CA); Minzhe Yu, Qingdao (CN); Jiawen He, Qingdao (CN); Zhipeng Zhao, Qingdao (CN); Youwei Zhao, Qingdao (CN); Huafeng Xue, Qingdao (CN); Yujia Pu, Qingdao (CN); Bin Zhang, Qingdao (CN); Ruichun Tang, Qingdao (CN); Xuening Wang, Qingdao (CN); Sirui Fan, Qingdao (CN); Jilin Chen, Qingdao (CN); Hao Zhou, Qingdao (CN)

(72) Inventors: Charles Changqing Li, Cross River, NY (US); Zhizhuang Wu, Vancouver (CA); Minzhe Yu, Qingdao (CN); Jiawen He, Qingdao (CN); Zhipeng Zhao, Qingdao (CN); Youwei Zhao, Qingdao (CN); Huafeng Xue, Qingdao (CN); Yujia Pu, Qingdao (CN); Bin Zhang, Qingdao (CN); Ruichun Tang, Qingdao (CN); Xuening Wang, Qingdao (CN); Sirui Fan, Qingdao (CN); Jilin Chen, Qingdao (CN); Hao Zhou, Qingdao (CN)

(21) Appl. No.: 18/363,948

(22) Filed: Aug. 2, 2023

(51) Int. Cl. G06Q 30/0601

(52) U.S. Cl. CPC G06Q 30/0607; G06Q 2220/16

(57) ABSTRACT

The invention discloses a copyright protection and royalty distribution method based on a NFT and its associated smart contracts. The smart contracts govern the initial minting, derivative minting, and trading of the NFT as well as the royalty distributions of every trades in the lifetime of the NFT, This method uses blockchain and NFT technology to manage and protect the copyright of digital music. The ownership and trade transaction records of the NFT are verified through blockchain technology and the distribution of digital music royalties are automated via smart contracts. According to the method of the present invention, the copyright of digital music can be made more transparent and secure, the distribution of royalties can be more just and efficient, and copyright infringement and improper resale can be avoided.

The invention relates to blockchain, NFT and smart contract technologies, in particular to a method for copyright protection and royalty distribution of media streaming digital music works.

### BACKGROUND

With the development of the Internet, streaming digital music has gradually become the mainstream form of music distribution. Under the catalysis of the epidemic, the world has accelerated into the era of streaming media, and more and more users listen to music through streaming media. Creators stream the music they create through streaming services, and listeners can listen to it conveniently at any time on any of their devices. However, there are many problems common to traditional streaming digital music services.

First, the great convenience of downloading and using streaming digital music has brought about unprecedented copyright issues. Because digital music is easy to copy and spread and the network is anonymous, unauthorized music plagiarism occurs frequently. With the increasing number of sophisticated tools online, more and more pirates evade the supervision of laws or websites, and carry out digital music plagiarism activities which makes the protection of music copyright more and more difficult. In addition to causing direct economic losses to the digital music industry, this situation will also weaken the motivation of music creators, making them unable to obtain reasonable benefits from their music works. At the same time, such behavior also violates the copyright of music creators and seriously affects the economic and cultural promotion of the music industry. Copyright controversies emerge endlessly in the streaming media era.

The second is the uneven distribution of income from music works. In the current digital music industry environment, streaming music is a one-time purchase of the copyright of a song from record companies or musicians, while the premium generated by songs on mobile music platforms is completely cut off from the original copyright owner. In fact, compared with song copyright fees, the returns obtained by mobile music platforms through advertising revenue, paid listening, scene marketing, etc. are at a relatively high level. Most of the current industry adopts a “prorated” business model, meaning that most of the subscription fees paid by users go to the top record labels, while smaller non-prime creators only receive a small part of it.

The digital music industry is currently undergoing major changes. The combination of NFT technology and streaming digital music has the potential to bring major benefits to the music industry. It could serve as an alternative or complement to digital music streaming services, exploring a new business model focused on catering to independent and non-major artists and labels. Musicians can earn additional income by permanently storing their music on the blockchain (minting songs as NFTs). Through music NFTs, musicians are opening up new sources of income beyond relying solely on albums, tours, and endorsements. Musicians can directly profit from intellectual property without relying on any third parties. Additionally, due to mechanisms built into the blockchain, NFTs allow creators to earn royalties from secondary sales and derivative music creations via minting derivative NFTs. These features help creators take control of their work and address the issue of musicians benefiting too little from streaming services.

### Contents of the Invention

An embodiment of the present invention provides a streaming digital music copyright protection and royalty distribution method based on NFT and smart contracts, including:

Use blockchain technology and NFT technology to manage and protect the copyright of digital music. Each digital music work corresponds to a non-replicable NFT, and the ownership and transaction records of the NFT can be verified through blockchain technology, thus making the copyright of digital music more transparent and secure.

Use the Solidity programming language to write the royalty distribution rules and reward mechanism of the smart contract, to automate and justify the distribution of digital music royalties, and to help control the resale of digital music.

First of all, smart contracts can manage the sales and playback data of digital music, and automatically calculate the rewards that each participant should receive according to the set rules. For example, according to the rights and interests of musicians, smart contracts can automatically distribute digital royalties to musicians, producers, record companies and other parties, and record the account balance of each participant in real time, so that the distribution of digital music royalties is more fair and efficient.

Secondly, if the NFT contains copyright information, the smart contract can automatically track the ownership and resale records of digital music, and change the distribution of copyright and royalties according to relevant rules, so as to avoid copyright infringement and improper resale and bring more protection and rewards to digital music creators.

### Implementation Detail

In the following, the technical solutions in the embodiments of the present invention will be clarified and explained in detail in conjunction with the accompanying diagrams in the embodiments of the present invention. Apparently, the described embodiments are only some of the embodiments of the present invention, not all of them. Based on the embodiments of the present invention, all other embodiments obtained by persons of ordinary skill in the art without creative work belong to the protection scope of the present invention.

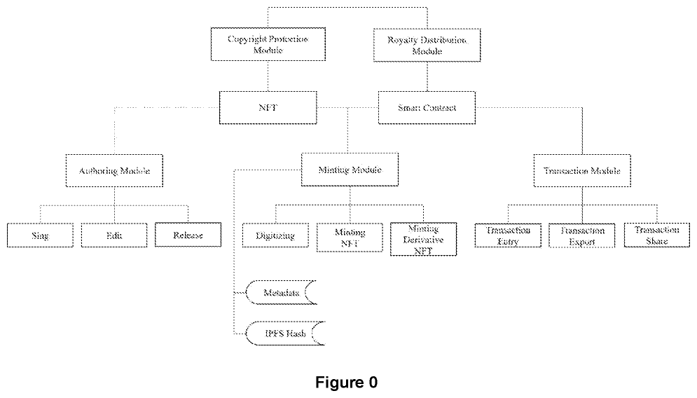

As shown in FIG. 0, it is a structural diagram of a copyright protection and royalty distribution method based on NFT and smart contracts according to an embodiment of the invention.

Copyright protection module. The copyright protection module is implemented by NFT, that is, each digital music work corresponds to a non-copyable NFT, and the ownership of the NFT is verified through blockchain technology.

Royalty distribution module. The royalty distribution module is implemented by smart contracts, and smart contracts are written and used according to relevant rules for the automatic and distribution of digital music royalties.

Minting modules. The minting module is jointly realized by NFT and smart contracts, including digitization, original minting (minting NFT), and derivative minting (minting derivative NFT). Through the minting function of the smart contract, a new NFT instance is created, and the metadata (such as author, name, description, etc.) and file links (such as IPFS hash) of the music work are received and passed to the smart contract, and associated with the work.

Creation module. Creation module includes music creation, editing and publishing by creators.

Transaction module (or trade module). The transaction module includes buy, sale, and profit sharing of music work's NFT.

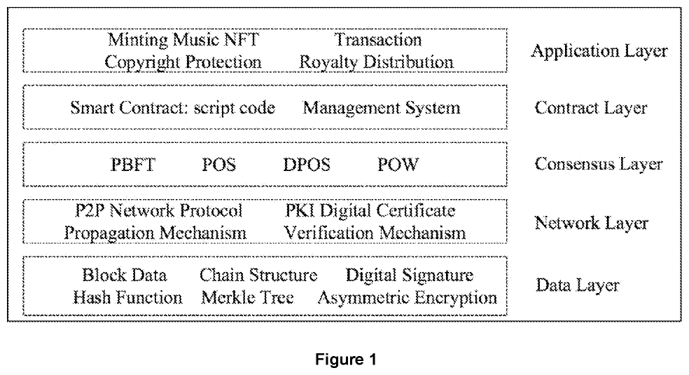

As shown in FIG. 1, it is a theoretical architecture diagram of a five-layer system based on NFT and smart contracts proposed by the embodiment of the present invention.

Data layer. At this layer, the security of data storage and account transactions is realized. Utilize Merkle tree, blockchain structure and KV database (such as LevelDB) to complete data storage. Cryptographic algorithms such as digital signatures, hash functions and asymmetric encryption techniques are used to ensure the security of transactions.

Network layer. In this layer, the connection and communication of network nodes are realized. Using peer-to-peer technology (P2P) to build a decentralized network system, combined with the propagation mechanism and verification mechanism, to ensure the robustness of the system.

Consensus layer. At this layer, the consistency of transactions and data between nodes in the entire network is realized. Choose an appropriate consensus algorithm, such as POW, POS, DPOS or PBFT, to prevent various consensus attacks.

Contract layer. At this layer, the writing and execution of smart contract script code is realized. Use virtual machine technologies such as Ethereum Virtual Machine (EVM) to run smart contract codes and provide users with programmable blockchain applications.

Application layer. At this layer, build a decentralized application (DAPP) based on the smart contract layer to realize the minting and trading of music NFT, protect the copyright of creators, and distribute royalties reasonably and efficiently. Provide users with a friendly front-end interface to achieve interaction with smart contracts, making blockchain technology closer to actual application scenarios.

In the five-layer architecture shown in FIG. 1, each layer depends on each other and cooperates to build a complete blockchain technology application implementation plan. In practical applications, the five-layer architecture can be customized and optimized according to specific business needs to meet the needs of different scenarios.

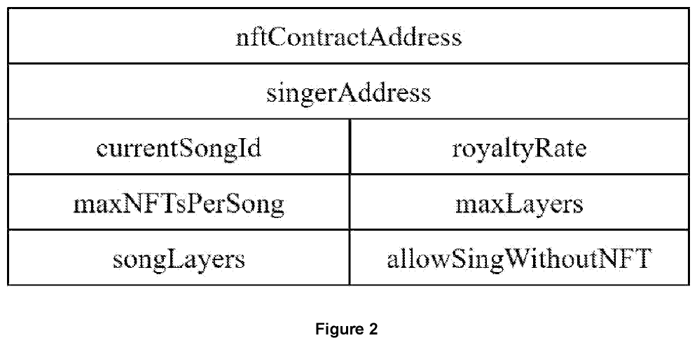

FIG. 2 is a data structure diagram of the smart contract designed in the embodiment of the present invention. The contract contains the following main structures and variables: nftContractAddress records the address of the NFT contract, which is convenient for using the contract in other contracts; singerAddress is the address of the current singer (creator), used to record singer information; currentSongId records the ID of the song currently sung as an identification character; royaltyRate is the song royalty rate, which is used to calculate royalties; maxNFTsPerSong and maxLayers are used to limit the maximum number of minting and minting layers of NFT for each song; songRecords and songLayers record the song's singing records and the number of layers that have been minted, respectively, for easy query and management; finally, allowSingWithoutNFT decides whether to allow users without NFT to sing, which improves the flexibility and practicability of the contract.

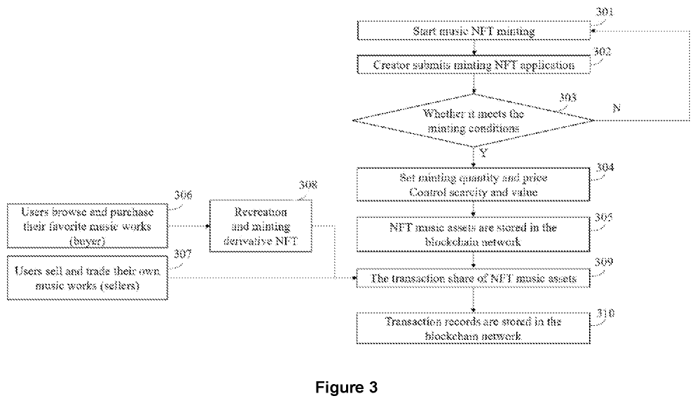

As shown in FIG. 3, it is a flow chart of NFT minting and trading on the vocal music creation and streaming platform (called NFT K) based on NFT and smart contracts according to the embodiment of the present invention.

Step 301, the music author or copyright owner uploads the music work to the platform, and mints the music work as a NFT. During this process, the platform will ensure the originality and copyright ownership of music works.

Step 302, the user registers on the platform and creates a wallet and submits a minting application (request). Wallet addresses will be also used to buy, sell and trade NFT music assets.

Step 303, judging whether the minting conditions are met, if so, proceed to step 304, the minting conditions include that the work is original and the work is allowed to be derivatively minted. Otherwise return to step 301.

In step 304, music authors or copyright owners can set the distribution quantity and price of NFT of the music as they desire and adjust the scarcity and value of musical works by controlling the number of releases and prices.

Step 305, the platform creates NFT based on the ERC-721 standard. After the creation is completed, the NFT will be stored in the blockchain network to ensure their uniqueness and immutability.

Step 306, the users browse the purchasable NFTs through the platform. They can search for their favorite music works and purchase them according to filter conditions such as music type, author, and price. During the purchase process, users need to pay for the corresponding tokens, which can be obtained by purchasing or participating in platform activities. After a successful purchase, the purchaser becomes the owner of the NFT.

Step 307, the users can sell or trade their own NFTs on the platform. During the transaction, the seller needs to set the selling price, and the buyer needs to pay for the corresponding tokens. After the transaction is completed, the ownership of the NFTs will be transferred to the new owner.

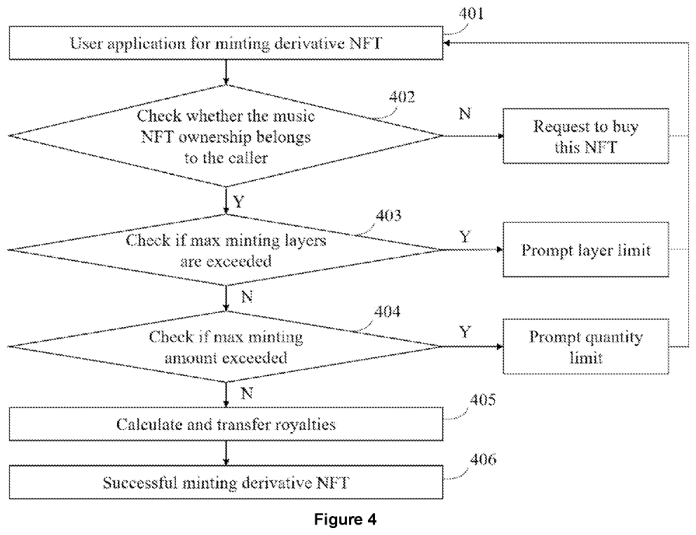

Step 308, the user performs derivative creation of music based on an existing music with minted NFT and proceeds a derivative minting of a NFT. When the user requests to mint a music NFT, the platform will verify whether the user owns the NFT of the music on top of which the user creates one's own music. After the verification is successful, the platform will allow the user to proceed to the next step. The specific details are introduced in the part of FIG. 4 and will not be repeated here.

In step 309, music NFT owners and copyright owners can obtain a trade profit share of NFT through the platform. Whenever a user buys or sells an NFT corresponding to a music work, a certain percentage of royalties will be distributed to the original music creator, and the remaining transaction amount will be distributed to the NFT seller, so as to realize the benefits of music creation automatically and efficiently

Step 310, after the transaction completes, the transaction record will be stored in the blockchain network to ensure that the copyright of digital music is more transparent and secure.

As shown in FIG. 4, it is a flow chart of derivative music creation and derivative minting of NFT based on the original music work in the embodiment of the present invention.

Step 401, the user submits a request to the platform for derivative minting of NFT based on the original music work.

Step 402, determine whether the NFT ownership belongs to the requester, if so, go to step 403. Otherwise, request to purchase the NFT, and return to step 401.

In step 403, it is determined whether the maximum number of minting layers of the NFT exceeds the threshold, and if so, it prompts that the number of layers exceeds the limit, and rejects the request of minting NFT. Otherwise, go to step 404.

In step 404, it is judged whether the maximum number of minted NFTs exceeds the threshold, and if so, it prompts that the quantity limit is exceeded, and rejects the request of minting NFT. Otherwise, go to step 405.

Step 405, calculating and transferring royalties for the derivative minting items that meet the above steps.

In step 406, a reminder of successful minting is provided, and the user can trade the minted derivative NFT works.

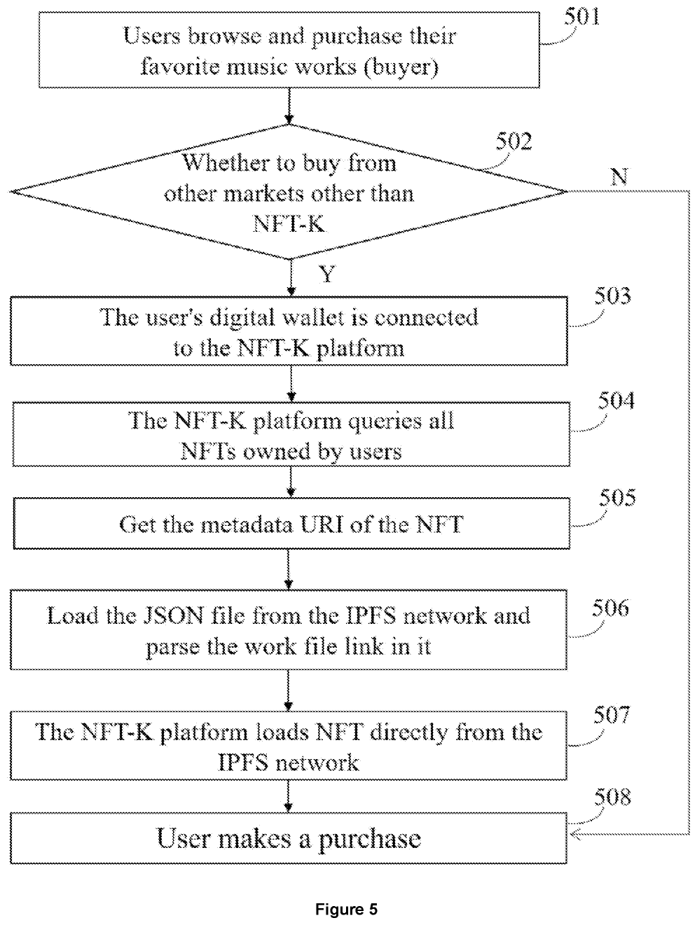

FIG. 5 is a flow chart of purchasing music NFT according to the embodiment of the present invention.

Step 501, the buyer enters the NFT music order platform through the mobile application or web app to browse and purchase music works according to their preferences.

Step 502, choose whether to buy from other markets other than NFT-K, if so, go to step 503, and the user's digital wallet needs to have relevant information and IPFS address. Otherwise, go to step 508.

Step 503, establish a connection with the NFT-K platform based on the relevant information in the user's digital wallet and the IPFS address. The user's digital wallet information will be displayed on the NFT-K platform.

Step 504, the NFT-K platform uses the user's public address to query all NFTs owned by the user on the selected blockchain network. This process is realized by calling two functions in the ERC721 standard.

Step 505, based on all the NFT information owned by the user, obtains the metadata URI of the NFT in the blockchain. URI is usually an IPFS address.

Step 506, load the JSON file on the IPFS network, and parse the link of the work file therein. IPFS is a distributed file system that consists of nodes on the network, each of which can store and replicate files.

Step 507, the NFT-K platform loads the NFT directly from the IPFS network without storing it on the server. In this way, the integrity and non-tampering of the work files are guaranteed, and the storage pressure on the server is reduced.

Step 508, the user purchases the selected music composition. The value ownership of NFT music works has changed from seller to buyer. And the buyer can also gain benefits by changing the holder of the NFT music work.

1. A karaoke media streaming system based on NFT and smart contracts, characterized in that it includes a copyright protection module and a royalty distribution module. The copyright protection module is mainly implemented through NFT technology, and each digital music work is corresponding to a NFT, and the ownership of the NFT is verified through blockchain technology. The royalty distribution module is mainly realized through the support of smart contracts, and according to relevant rules, smart contracts are written and used for automatic and distribution of royalties of digital music works.

2. The copyright protection method for digital music works according to claim 1, comprises a creation module, a minting module and a trade module. The creation module is used by creators to create, perform, edit and publish music works. The minting module includes digitization of works, original minting and derivative minting. The trade module includes buy, sale, and profit sharing of music works through smart contracts of NFT.

3. In claim 2 the original minting of a NFT is characterized in that the minting function of the smart contract is called to create a new NFT instance, and the metadata (such as author, name, description, etc.) of the music work is received, and file links (such as IPFS hash) are passed to the smart contracts, a unique Token ID is assigned to the NFT, and it is associated with the music work, and finally the minting history of the NFT is recorded on the blockchain network, including the minting time, author and original right holder and other information.

4. In claim 2 the derivative minting of a NFT is characterized in that the prerequisite for the user to proceed derivative minting is to have the ownership of the NFT of the music work, and further check whether the maximum minting quantity and the maximum number of minting layers are exceeded, if the above conditions are met, the derivative minting is successful.

5. The method for distributing royalties for digital music works according to claim 1, characterized in that, in the process of changing hands of NFT music works, relying on the distribution rules stipulated in the smart contract, a certain proportion of the transaction amount is delivered to the original creator(s) as royalties, the remaining transaction amount is delivered to the seller, and the transaction records are stored in the blockchain network.
